(19) United States
(12) Patent Application Publication
(10) Pub. No.: US 2007/0156293 A1
(43) Pub. Date: Jul. 5, 2007

(54) Interface system

(76) Inventors: Krikor George Kellzi, Glendale, CA (US); Moti Segal, Northridge, CA (US)

Correspondence Address: LAW OFFICES OF LARRY K. ROBERTS, INC., 2 Park Plaza, Suite 300, Irvine, CA, 92614, US

(21) Appl. No.: 11/323,277

(22) Filed: Dec. 30, 2005

(51) Int. Cl. G05D 1/00

(52) U.S. Cl. 701/1

(57) ABSTRACT

An interface system for interfacing between a vehicle security system and one or more USB peripheral devices.

### BACKGROUND

Vehicle security systems may control or connect to external devices such as sirens, lights, cameras, tracking systems and receiver/transmitters. The devices may require adaptation or special circuitry to connect to the vehicle security system to allow commands and data to be passed between the security system and external devices.

### BRIEF DESCRIPTION OF THE DRAWINGS

FIG. 1 is a simplified schematic diagram of an exemplary embodiment of an automotive security system with an interface unit for USB peripheral devices.

FIG. 2 is a schematic diagram illustrating an exemplary embodiment of a vehicle security system.

FIG. 3 is a simplified flow diagram illustrative of an exemplary embodiment of a general process flow of the interface unit.

FIG. 4 is a schematic diagram of an alternate embodiment of a vehicle security system.

### DETAILED DESCRIPTION

In the following detailed description and in the several figures of the drawing, like elements are identified with like reference numerals. The FIGS. are not to scale, and relative feature sizes may be exaggerated for illustrative purposes.

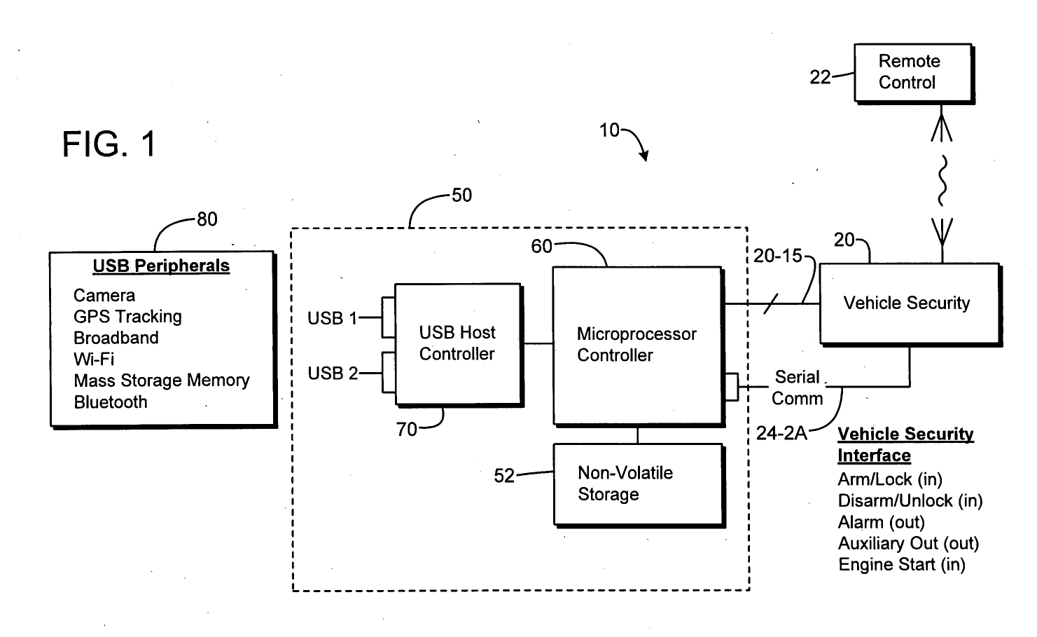

An exemplary embodiment of a vehicle security system 10 with USB peripheral connectivity is depicted in FIG. 1. In an exemplary embodiment, the system includes a vehicle security system 20, which is installed in a user's vehicle. The security system 20 may be an after-market system, installed after manufacture of the vehicle. Alternatively, the system 20 may be installed during manufacture of the vehicle. Such a system 20 may include a receiver for receiving encoded commands from a remote transmitter to control functions of the security system 20. The system 20 in an exemplary embodiment includes an electronic controller programmed to carry out functions in response to commands received from the remote control 22, and respond to stimuli from sensors and triggers comprising the system 20. By way of example, the system 20 may be put into an armed state, e.g. by a remote control command or by passive arming, or into a disarmed state. The system 20 may be placed in an alarmed state in response to sensor or trigger signals indicating door opening, window breakage or the like. Entering the alarm state may cause an alarm to be triggered, e.g. activating a siren or flashing vehicle lights. Arming the system 20 may cause the system to disable a vehicle ignition or engine, lock the vehicle door, or take other measures.

In this exemplary embodiment, the system 10 further includes an interface unit 50 for interfacing between one or more universal serial bus (USB) peripheral devices 80. A USB peripheral is a device that connects to a USB controller using the USB defined protocol. Some examples of these peripherals include a USB digital camera, a USB memory stick, a USB WIFI adapter, and a USB GPS. The devices 80 may also be compliant with the USB On-the-Go (OTG) protocol, e.g. as described in the “On-The-Go Supplement to the USB 2.0 Specification, Revision 1.0a, Jun. 24, 2003, and may be a OTG dual-role device, which can act as either a host to certain USB or OTG peripherals or as a peripheral to standard USB or dual-role hosts. The interface unit 50 in an exemplary embodiment includes a microprocessor-based controller 60, a non-volatile storage memory 52 connected to the controller 60 and a USB controller 70 interfaced to the controller 60.

Exemplary USB controllers suitable for the purpose of controller 70 are commercially available. For example, the TD242LP controller model, marketed by TransDimension Inc., Irvine, Calif, is a Host, Peripheral and On-the-Go controller system, which may be employed as a controller 70 in an exemplary embodiment, and which supports interfacing to microprocessors.

The microprocessor controller 60 is interfaced to the vehicle security system to receive security system state signals indicative of security system parameters, e.g., system state. The interfacing of the controller 60 to the vehicle security system may be via a serial communication bus 24-2A. Alternatively, the interfacing may be by direct wiring 20-15 of signals indicative of the various states of the security system, e.g., outputs of the controller of the vehicle security system to I/O ports of the controller 60. For example, the security system may include an alarm output which controls a siren and which may also be coupled to the interface unit 50.

In another embodiment, the functions of the microprocessor controller 60 and the USB host controller 70 may be performed by a single device or integrated circuit. For example, an MCF532x 68K/ColdFire or MCF532x 68K/ColdFire microprocessor by Freescale Semiconductor may be employed, and incorporates USB host and USB On-the-go controllers.

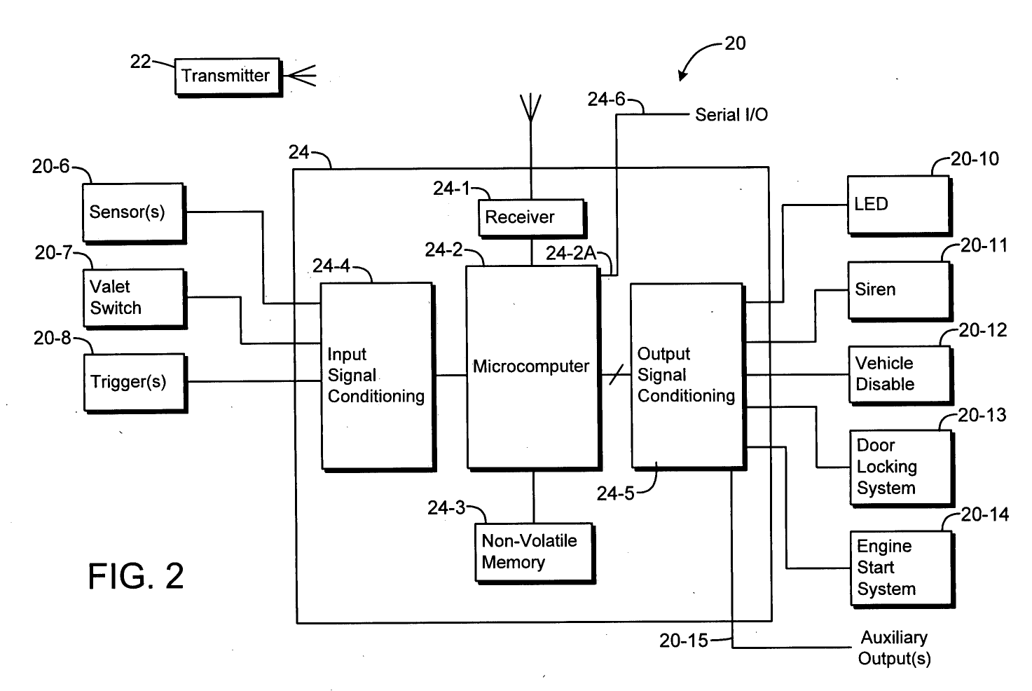

FIG. 2 is a schematic diagram illustrating an exemplary embodiment of a vehicle security system 20. In one application for the interface unit 50, the security system 20 is an “after-market” system, i.e. one installed in a vehicle after its manufacture. This may be done, for example, by the vehicle owner after taking delivery, or even by a manufacturer or distributor or dealer, who installs the security system in the vehicle. A dealer may have a security system installed in a new vehicle, for example, as part of a sale or to enhance salability of the vehicle. Such after-market vehicle security systems are well known in the art.

Still referring to FIG. 2, the security system 20 includes a wireless transmitter for transmitting commands to the system controller 24. In this exemplary embodiment, the controller 24 includes a receiver 24-1 with an antenna for receiving the wireless commands from the transmitter 22 and converting the wireless signals into digital signals compatible with the microcomputer 24-2. The controller 24 may also include a non-volatile memory 24-3, input signal conditioning circuitry 24-4 and output signal conditioning circuitry 24-5. In this exemplary embodiment, the microcomputer includes a serial I/O line 24-6, which may be coupled to the interface unit 50 (FIG. 1). The controller 24 may be responsive to various input signals, e.g. signals from one or more sensors 20-6, a valet switch 20-7 and trigger switches 20-8. Examples of sensors include proximity or motion sensors and audible sound sensors for detecting window breakage or the like. Examples of trigger switches include door switches, hood switches and hatch switches for detecting opening/closing of the vehicle doors, hood and hatches. The valet switch is a user-accessible switch, typically located in the passenger's compartment, to allow the user to switch off, program or otherwise control the security system. The controller 24 includes input signal conditioning circuitry 2-4 to convert signals from the sensors 20-8, switch 20-7 and 20-8 to a signal level and type compatible with the microcomputer 24-2.

In an exemplary embodiment, the microcomputer 24-2 includes a serial I/O port 24-2A which may be connected to the interface unit 50 to provide data to the interface unit 50. For example, the serial data may include status or state data regarding the current status or state of the security system, e.g. whether the system 20 is armed or disarmed, whether the system is in an armed state, an entry violation or alarm state, a zone malfunction state, a Valet state, an engine run status, or other known or presently unknown vehicle security system states or status conditions.

The vehicle security system may include devices which are controlled by the controller 24, e.g. an LED status indicator 20-10, a siren 20-11 which may be used to signal an alarm with an audible alert signal, a vehicle disable circuit 20-12 to disable the operation of the vehicle when the system is armed, or when in the alarm state, a power door locking system 20-13 for locking/unlocking the vehicle doors, an engine start system 20-14 for remotely starting the vehicle engine, and one or more auxiliary outputs 20-15. The auxiliary outputs may be connected, for example, to an output terminal of the microcomputer or to the output signal conditioning circuitry 24-5. The auxiliary outputs may be provided to the interface unit 50 to provide data regarding the status or state of the security system, in the event the microcomputer does not employ a serial I/O bus to provide data to the interface unit.

The controller 60 of the interface unit 50 may be programmed to send commands to the USB controller 70 in response to particular states of the vehicle security system. For example, consider the case in which a USB enabled security camera is attached to USB port 1 of the controller 70. The interface controller 60 may be programmed or adapted to instruct the USB controller 70 to activate the security camera when the vehicle security system is put in the armed mode, e.g. to capture images of a surveillance scene at the vehicle on a scheduled periodic basis, and to store the captured images in the storage 52. Additionally or alternatively, the controller 60 may be programmed to instruct the USB controller 70 to activate the USB camera to capture an image or video of the surveillance scene if the vehicle security system is put into the alarm mode, e.g. in response to an alarm event while the system 20 is in the armed state. Once an alarm has been triggered and a connected USB-compatible GPS device 80 determines that the vehicle is in motion, a connected USB broadband device 80 may alert the user or other monitoring service of the unfolding event. In addition, a digital image and real time video may be transmitted. For example, a cell phone connected to cellular wireless Internet service may be employed to send an alert via email or a voice mail to a predetermined address, describing the nature of the alert. USB cellular data kits are commercially available, such as, for example, the data kit marketed by Ositech, www.ositech.com, and may be employed to provide internet connectivity. A USB wireless network interface device may be connected as a USB peripheral device, to provide a wireless connection in an area having wireless signal coverage, e.g. a WIFI “hot spot”. A WIFI device application may, for example, be used in lot security and fleet management. A WIFI “hot spot” may cover all vehicles parked in a parking lot. A vehicle security violation or alert may be reported automatically via the network to a central computer. One or more of the connected USB devices may have its own IP (internet protocol) address.

A connected USB mass storage memory 80 may be used to store GPS tracking history, as well as video and image files. A USB memory stick, for example, may record GPS data of the vehicle for a period of time for later review of the vehicle travel.

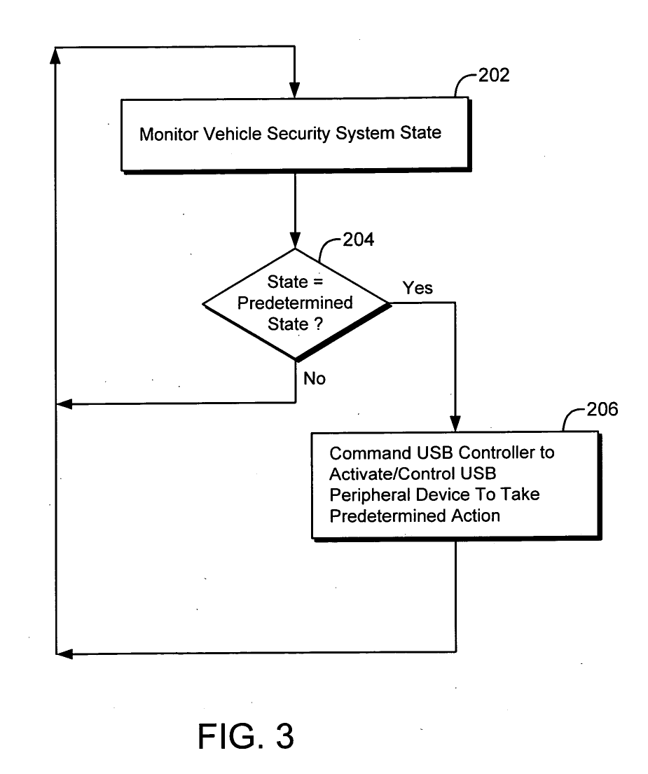

FIG. 3 is a simplified flow diagram illustrative of an exemplary embodiment of a general process flow 200 of the programmed controller 60. At step 202, the controller monitors the vehicle security system state, e.g. by keeping track of data received via a serial I/O bus. In the event the state is a particular predetermined state, e.g. the alarm state, determined at 204, then at 206 the controller 60 commands the USB controller 70 to activate or control an attached USB peripheral device 80 to take a certain predetermined action. For example, say the vehicle security system enters an alarm mode. Upon receipt of this state information, the controller 60 instructs the USB controller 70 to control a USB camera connected to the interface unit 50 to record an image or series of images of a scene at the vehicle, e.g. to record an image of a thief. Additionally, or alternatively, in the case in which the connected USB peripheral devices 80 includes a GPS device to monitor vehicle location, the vehicle location data may be recorded, and/or transmitted, e.g. via a wireless internet connection through a connected USB WIFI adaptor, to a user or monitoring service.

The USB peripheral devices 80 may include, in an exemplary embodiment, one or more of the attached devices for the vehicle-security system.

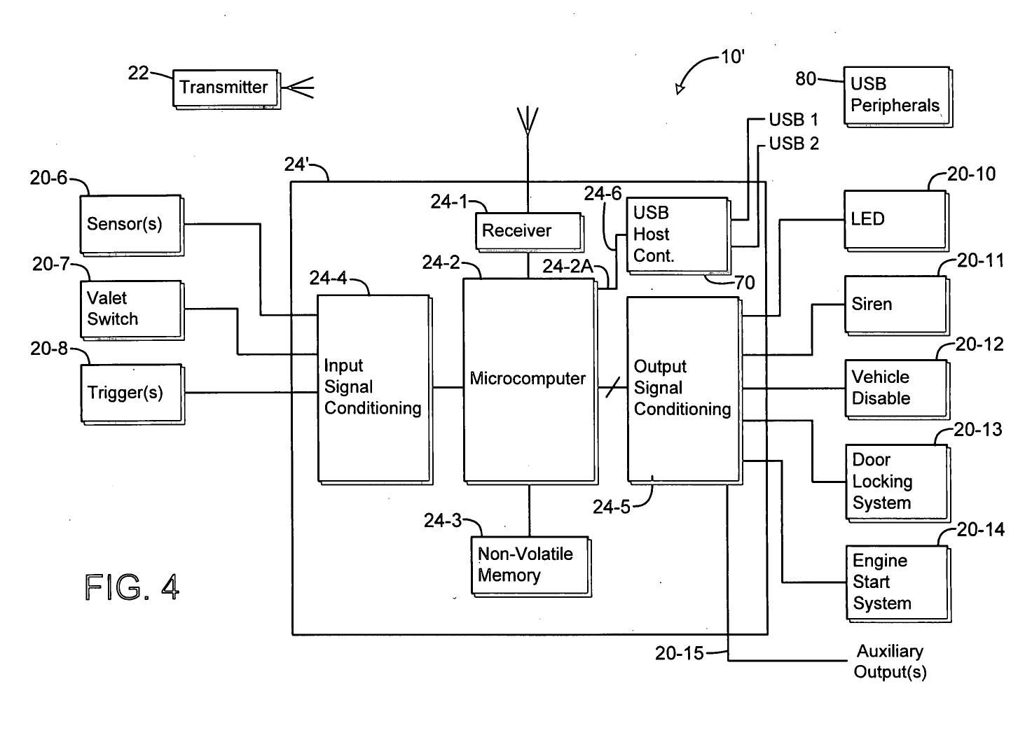

The interface unit 50 of FIG. 1 may be marketed separately from an after-market vehicle security system embodiment, so that a user or vehicle owner may add the unit 50 to his vehicle to provide enhanced connectibility to USB peripherals. The functionality of the interface unit 50 may alternatively be incorporated into the vehicle security system controller, as depicted in the schematic diagram of FIG. 4. Here, for example, a vehicle security system 10′ includes a security system controller 24′, which in turn includes the function of a USB host controller 70. In this example, the microcomputer 24-2 of the controller 20′ is programmed to perform the functions of the microprocessor 60 of the interface unit 50 (FIG. 1) in addition to those of the security system controller, and to communicate status information regarding the security system-with the USB host controller 70. In other respects, the vehicle security system 10′ is similar to the system 10 of FIG. 1, and may be connected to one or more USB peripheral devices 80 through the USB ports, e.g. USB 1 or USB 2, of the USB host controller 70.

Although the foregoing has been a description and illustration of specific embodiments of the invention, various modifications and changes thereto can be made by persons skilled in the art without departing from the scope and spirit of the invention as defined by the following claims

What is claimed is:

1. An interface system for interfacing between a vehicle security system including a security controller and one or more USB peripheral devices, comprising:
a system controller connected to the security controller and responsive to security system state signals from the security controller;
a USB controller in electronic signal communication with the system controller;
at least one USB peripheral port for connection to the one or more USB peripheral devices.

2. The system of claim 1, wherein the system controller is adapted to issue a command signal to the USB controller in response to a security system state signal from the security controller to generate a peripheral signal on said at least one USB peripheral port to cause a USB peripheral device connected to the at least one USB peripheral port to perform a desired function.

3. The system of claim 1, wherein the security system state signals include an alarm state signal and wherein the system controller is adapted to respond to said alarm state signal by commanding-the USB controller to activate the USB peripheral device.

4. The system of claim 3, wherein the USB device is a camera.

5. The system of claim 1, wherein the USB peripheral device is one of the group consisting of a security camera, a position tracking device, a mass storage memory device, a broadband internet connection, and a wireless internet connection.

6. The system of claim 1, wherein the security system has an armed state, a disarmed state and an alarm state.

7. The system of claim 1, wherein the at least one USB peripheral port includes a first USB peripheral port and a second USB peripheral port.

8. The system of claim 1, further comprising:
a non-volatile memory connected to the system controller.

9. The system of claim 1, in combination with a vehicle security system.

10. The system of claim 1, wherein the system controller and the USB controller are fabricated on a single integrated circuit device.

11. A vehicle security system, comprising:
a security controller;
one or more devices for providing input signals to the security controller;
one or more output devices responsive to output signals generated by the security controller;
one or more USB peripheral devices; and
an interface system for interfacing between the security controller and said one or more USB peripheral devices, comprising:
an interface controller responsive to security system state signals from the security controller;
a USB controller in electrical communication with the interface controller;
at least one USB peripheral port.

12. The system of claim 11, wherein the interface controller is adapted to issue a command signal to the USB controller in response to a security system state signal from the security controller to generate a peripheral signal on said at least one USB peripheral port to cause a USB peripheral device connected to the at least one USB peripheral port to perform a desired function.

13. The system of claim 11, wherein the security system state signals include an alarm state signal and wherein the system controller is adapted to respond to said alarm state signal by commanding the USB controller to activate the USB peripheral device.

14. The system of claim 13, wherein the USB device is a camera.

15. The system of claim 11, wherein the USB peripheral device is one of the group consisting of a security camera, a position tracking device, a mass storage memory device, a broadband internet connection, and a wireless internet connection.

16. The system of claim 11, wherein the security system has an armed state, a disarmed state and an alarm state.

17. The system of claim 16, wherein the at least one USB peripheral port includes a first USB peripheral port and a second USB peripheral port.

18. The system of claim 11, wherein the system controller and the USB host controller are fabricated on a single integrated circuit device.

19. The system of claim 11, wherein the input devices include at least one of a sensor, a trigger or a valet switch.

20. The system of claim 11, wherein the output devices include at least one of a siren, a vehicle disable circuit or a door locking system.

21. A vehicle security system, comprising:
a security controller;
one or more devices for providing input signals to the security controller;
one or more output devices responsive to output signals generated by the security controller;
a USB controller interfaced to the security controller to received command signals and including at least one USB peripheral port;
a USB peripheral device connected to the at least one USB peripheral port;
and wherein the security controller is adapted to issue a command signal to the USB controller to generate a peripheral signal on said at least one USB peripheral port to cause a USB peripheral device connected to the at least one USB peripheral port to perform a desired function.

22. The system of claim 21, wherein the security system may be put into an alarm state and wherein the security controller is adapted to respond to said alarm state by commanding the USB controller to activate the USB peripheral device.

23. The system of claim 21, wherein the USB device is a camera.

24. The system of claim 21, wherein the USB peripheral device is one of the group consisting of a security camera, a position tracking device, a mass storage memory device, a broadband internet connection, and a wireless internet connection.

25. The system of claim 21, wherein the security system has an armed state, a disarmed state and an alarm state.

26. The system of claim 21, wherein the input devices include at least one of a sensor, a trigger or a valet switch.

27. The system of claim 21, wherein the output devices include at least one of a siren, a vehicle disable circuit or a door locking system.
